(19) United States
(12) Patent Application Publication
(10) Pub. No.: US 2010/0292381 A1
(43) Pub. Date: Nov. 18, 2010

(54) THERMOPLASTIC RESIN COMPOSITION AND MOLDED BODY OBTAINED BY MOLDING THE SAME

(75) Inventor: Hiroo Kamikawa, Kyoto (JP)

Correspondence Address: FILDES & OUTLAND, P.C., 20916 MACK AVENUE, SUITE 2, GROSSE POINTE WOODS, MI, 48236, US

(73) Assignee: UNITIKA LTD., Hyogo (JP)

(21) Appl. No.: 12/745,760

(22) PCT Filed: Dec. 19, 2008
(86) PCT No.: PCT/JP2008/003855

§ 371 Date: Jun. 2, 2010

(30) Foreign Application Priority Data
Dec. 20, 2007 (JP) 2007-328678

(51) Int. Cl. C08K 5/14

(52) U.S. Cl. 524/394

(57) ABSTRACT

Disclosed is a thermoplastic resin composition obtained by mixing together 100 parts by mass of a polylactic acid resin or a polylactic acid resin composition, 0.01 to 10 parts by mass of a peroxide and 0.01 to 5 parts by mass of a silane compound having two or more functional groups selected from an alkoxy group, an acrylic group, a methacrylic group and a vinyl group. The polylactic acid resin composition may include 90 to 99.5% by mass of the polylactic acid resin and 0.5 to 10% by mass of a plasticizer. The thermoplastic resin composition may further include a fibrous reinforcing material and a polycarbodiimide compound, and where necessary, a flame retardant.

### TECHNICAL FIELD

The present invention relates to a thermoplastic resin composition and a molded body obtained by molding the same.

### BACKGROUND ART

As the material for molding a molded body, generally used are the resins such as polypropylene (PP), acrylonitrile-butadiene-styrene copolymer resin (ABS), polyamide (PA6, PA66), polyester (PET, PBT) and polycarbonate (PC). However, although the molded bodies produced from such resins are excellent in moldability and mechanical strength, such molded bodies increase waste amount when discarded and are scarcely degraded in the natural environment, and hence remain semi-permanently in the ground even when buried in the ground. Additionally, these resins are resins produced from petroleum as the starting material, and create large environmental loads over the whole life cycle.

On the other hand, nowadays, from the viewpoint of the environmental preservation, resins produced by using materials derived from plants, including polylactic acid, are attracting attention. Among such resins, polylactic acid is one of the resins having the highest heat resistance, and is compatible with mass production to be low in cost and is highly useful. Further, polylactic acid is capable of being produced by using as materials plants such as corn and sweet potato to be able to contribute to the saving of the exhaustible resources such as petroleum.

However, even polylactic acid that is high in heat resistance among the resins produced from materials derived from plants is lower in heat resistance than ABS and polyester, when the degree of crystallization of polylactic acid is low, and hence polylactic acid is hardly said to have a heat resistance sufficiently satisfactory in practical use. In general, the resistance temperature satisfactory for practical use is said to be 50 to 70° C. indoors and 90° C. for in-vehicle use such as for use in automobiles. In consideration of the safety in use, the durability to the atmospheric temperature of 100° C. is practically required. Polylactic acid is a crystalline resin, but the crystallization rate is slow such that the crystallization of polylactic acid does not proceed sufficiently within the same time period as the die cooling time in the injection molding of the above-described general-purpose plastics such as PP, and the heat resistance of polylactic acid is in the vicinity of 60° C. For the purpose of improving the heat resistance, there is a method in which a crystal nucleating agent such as talc is added to polylactic acid to increase the crystallization rate at the time of molding of polylactic acid, and thus the degree of crystallization is increased. However, for the purpose of making the crystallization proceed, even such a method needs a long die cooling time.

For the purpose of solving the above-described problems, there has been proposed a method in which a crosslinking agent such as a peroxide and a crosslinking aid such as acrylic acid ester are mixed to effectively introduce a crosslinking structure into polylactic acid and thus the crystallization rate is improved (JP2005-232225A). Further, it has been found that mixing of a specific plasticizer enables drastic increase of the crystallization rate (WO2007/049529).

However, these methods are still insufficient from the viewpoint of the molding cycle, and further, disadvantageously the heat rigidity of polylactic acid is not sufficient even when polylactic acid is crystallized. The heat rigidity as referred to herein means a measure of how hardly deformed is a molded body under a given load in a high temperature environment. For example, the deflection temperature under load (DTUL) of the above-described crosslinked polylactic acid is 100° C. or higher when measured under the condition of the maximum stress of 0.45 MPa, but is approximately 60° C. when measured under the condition of a high load of 1.8 MPa. Accordingly, such heat resistance cannot be said as sufficient in applications that involve high temperatures and high loads or in large molded articles themselves having large weights. Additionally, for the purpose of making the crystallization of polylactic acid proceed in the injection molding, the die temperature is required to be increased to the vicinity of the crystallization temperature. However, because polylactic acid has a low heat rigidity at the crystallization temperature of itself, when the resistance at the time of releasing is large, disadvantageously the injector pin exerts a high pressure to deform the molded article.

For the purpose of solving the problem of the heat rigidity, a method in which an inorganic reinforcing material such as glass fiber or talc is mixed is also available. For example, JP2006-176652A has proposed a composition in which a glass fiber is mixed with a crosslinked polylactic acid. According to this composition, the crystallization rate is improved as compared to conventional polylactic acids, and further the problem of the heat rigidity is considerably overcome. However, as compared to general-purpose resins, such a composition still cannot be said to result in sufficient performances.

Additionally, with respect to the strength, polylactic acid is lower as compared to glass fiber-reinforced polyamide (PA+GF) and cannot be said to have a practical strength that allows polylactic acid to replace with PA+GF. Nowadays, the size reduction of products such as cellular phones and small personal laptop computers is promoted, resin parts such as the exterior parts thereof are required to have thin walls, and accordingly the use proportion of PA+GF high in rigidity has been increased. With respect to polylactic acid, when the strength thereof as well as the rigidity thereof is not sufficiently high, the trouble of cracking tends to occur. In the composition of the glass fiber-reinforced polylactic acid (PLA+GF), the strength thereof is required to be at least approximately the same as the strength of PA+GF.

### DISCLOSURE OF THE INVENTION

### Problems to be Solved by the Invention

The present invention solves the above-described problems, and an object of the present invention is to increase the crystallization rate of polylactic acid, also to improve the heat rigidity of polylactic acid and further to improve the strength of polylactic acid.

Further, the present invention intends to provide a resin composition and a molded body in both of which the improvement of the handleability with respect to the production, the improvement of the heat resistance based on the crystallization of polylactic acid, and the improvement of the handleability at the time of molding are attained, for example, in such a way that it is possible to reduce the take-out time of the product at the time of molding.

### Means for Solving the Problems

The present inventors diligently made a study for the purpose of solving the above-described problems, and consequently, have discovered that a resin composition including a polylactic acid resin, a peroxide and a specific silane compound and a resin composition further including a fibrous reinforcing material and a carbodiimide compound enable the above-described object to be achieved. Specifically, the gist of the present invention is as follows.

(1) A thermoplastic resin composition, wherein the thermoplastic resin composition is obtained by mixing together 100 parts by mass of a polylactic acid resin or a polylactic acid resin composition, 0.01 to 10 parts by mass of a peroxide and 0.01 to 5 parts by mass of a silane compound having two or more functional groups selected from an alkoxy group, an acrylic group, a methacrylic group and a vinyl group.

(2) The thermoplastic resin composition according to (1), wherein the polylactic acid resin composition includes 90 to 99.5% by mass of the polylactic acid resin and 0.5 to 10% by mass of a plasticizer.

(3) The thermoplastic resin composition according to (2), wherein the plasticizer is one or more selected from an aliphatic polycarboxylic acid ester derivative, an aliphatic polyhydric alcohol ester derivative, an aliphatic oxyester derivative, an aliphatic polyether derivative and an aliphatic polyether polycarboxylic acid ester derivative.

(4) The thermoplastic resin composition according to any one of (1) to (3), further including as a crystal nucleating agent one or more selected from an organic amide compound, an organic hydrazide compound, a carboxylic acid ester compound, an organic sulfonic acid salt, a phthalocyanine compound, a melamine compound and an organic phosphonic acid salt.

(5) The thermoplastic resin composition according to (4), wherein the crystal nucleating agent is one or more selected from a metal salt of dimethyl 5-sulfoisophthalate, N,N′,N″-tricyclohexyl trimesic acid amide, N,N′-ethylenebis(12-hydroxystearic acid) amide and octanedicarboxylic acid dibenzoyl hydrazide.

(6) The thermoplastic resin composition according to any one of (1) to (5), wherein the polylactic acid resin is mainly composed of polylactic acid.

(7) The thermoplastic resin composition according to any one of (1) to (6), wherein polylactic acid is produced from a plant material.

(8) A thermoplastic resin composition comprising 39.9 to 89.9% by mass of the thermoplastic resin composition according to any one of (1) to (7), 60 to 10% by mass of a fibrous reinforcing material and 0.1 to 10% by mass of a polycarbodiimide compound in relation to 100% by mass of the total amount of the thermoplastic resin composition.

(9) A thermoplastic resin composition comprising 36.9 to 86.9% by mass of the thermoplastic resin composition according to any one of (1) to (7), 10 to 60% by mass of a fibrous reinforcing material, 3 to 30% by mass of a flame retardant and 0.1 to 10% by mass of a polycarbodiimide compound in relation to 100% by mass of the total amount of the thermoplastic resin composition.

(10) The thermoplastic resin composition according to (8) or (9), wherein the fibrous reinforcing material is a glass fiber having an oblate cross section.

(11) A molded body obtained by molding the thermoplastic resin composition according to any one of (1) to (10).

### ADVANTAGES OF THE INVENTION

According to the present invention, provided are a thermoplastic resin composition which has an excellent heat resistance, an excellent strength and an excellent moldability, and a low degree of dependence on the petroleum-derived products, and a molded body based on the composition. The molded body is applicable to an injection molded body or the like and uses a natural product-derived biodegradable resin, and hence has an extremely high industrial applicability, for example, in such a way that the molded body can contribute to the saving of the exhaustible resources such as petroleum.

### BEST MODE FOR CARRYING OUT THE INVENTION

Hereinafter, the present invention is described in detail.

The thermoplastic resin composition of the present invention includes as the constituent components thereof a polylactic acid resin (A), a peroxide (B), a silane compound (C), a plasticizer (D), a crystal nucleating agent (E), a fibrous reinforcing material (F), a polycarbodiimide compound (G) and a flame retardant (H).

Examples of the polylactic acid resin (A) used in the present invention include poly(L-lactic acid) and poly(D-lactic acid), and further may include the resin compositions obtained by mixing with these polylactic acids as the main component, for example, the following: polyglycolic acid, polycaprolactone, polybutylene succinate, polyethylene succinate, polybutylene adipate terephthalate and polybutylene succinate terephthalate. From the viewpoint of the saving of the petroleum resources, materials originating from plants are preferable, and from the viewpoints of the heat resistance and the moldability, it is preferable to use, among such materials, poly(L-lactic acid), poly(D-lactic acid) and the mixture or copolymer of these. From the viewpoint of the biodegradability, the resin composition is preferably mainly composed of poly(L-lactic acid).

The polylactic acid mainly composed of poly(L-lactic acid) is varied in the melting point thereof depending on the proportion of the D-lactic acid component. In the present invention, in view of the mechanical properties and the heat resistance of the molded body, the melting point of the polylactic acid is preferably 160° C. or higher. For the purpose of setting the melting point of the polylactic acid mainly composed of poly(L-lactic acid) at 160° C. or higher, the proportion of the D-lactic acid component is preferably set at about less than 3 mol %.

The melt flow rate of the polylactic acid resin (A) at 190° C. under a load of 21.2 N is preferably 0.1 to 50 g/10 min, more preferably 0.2 to 20 g/10 min and most preferably 0.5 to 10 g/10 min. When the melt flow rate exceeds 50 g/10 min, the melt viscosity is too low and accordingly the mechanical properties and the heat resistance of the molded body may be poor. On the other hand, when the melt flow rate is less than 0.1 g/10 min, the load at the time of molding is too high, and hence the operability may be degraded.

The polylactic acid resin (A) is usually produced by a heretofore known melt polymerization method, or by further using in combination a solid-phase polymerization method. As a method for regulating the melt flow rate of the polylactic acid resin (A) so as to fall within a predetermined range, when the melt flow rate is too high, usable is a method in which a small amount of a chain extending agent such as a diisocyanate compound, a bisoxazoline compound, an epoxy compound or an acid anhydride is used to increase the molecular weight of the resin. In contrast, when the melt flow rate is too low, usable is a method in which a biodegradable polyester resin having a high melt flow rate or a low molecular weight compound is mixed with the polylactic acid resin (A).

The plasticizer (D) used in the present invention is not particularly limited; however, the plasticizer (D) is preferably excellent in the compatibility with the polylactic acid resin (A). Examples of the plasticizer (D) include one or more selected from an aliphatic polycarboxylic acid ester derivative, an aliphatic polyhydric alcohol ester derivative, an aliphatic oxyester derivative, an aliphatic polyether derivative, an aliphatic polyether polycarboxylic acid ester derivative and the like. Specific examples of the plasticizer (D) include glycerin diacetomonolaurate, glycerin diacetomonocaprate, polyglycerin acetate, polyglycerin fatty acid esters, medium chain fatty acid triglyceride, dimethyl adipate, dibutyl adipate, triethylene glycol diacetate, methyl acetylrecinolate, acetyl tributylcitrate, polyethylene glycol, dibutyl diglycol succinate, bis(butyl diglycol) adipate and bis(methyl diglycol) adipate. Specific examples of commercially available plasticizers, in terms of trade names, include PL-012, PL-019, PL-320 and PL-710 and Actor Series (M-1, M-2, M-3, M-4 and M-107FR) manufactured by Riken Vitamin Co., Ltd.; ATBC manufactured by Taoka Chemical Co., Ltd.; BXA and MXA manufactured by Daihachi Chemical Industry Co., Ltd.; and Chirabazol VR-01, VR-05, VR-10P, VR-10P Modification 1 and VR-623 manufactured by Taiyo Kagaku Co., Ltd.

The mixing amount or the content of the plasticizer (D) is required to be 0.5 to 10% by mass and is preferably 1 to 5% by mass in relation to 100% by mass of the total amount of the polylactic acid resin (A) and the plasticizer (D). When the mixing amount or the content of the plasticizer (D) is less than 0.5% by mass, the effect of the plasticizer (D) is poor. When the mixing amount or the content of the plasticizer (D) exceeds 10% by mass, even if the molded article has a high degree of crystallization, the heat resistance of the molded article is degraded.

Specific examples of the peroxide (B) used in the present invention include benzoyl peroxide, bis(butylperoxy)trimethylcyclohexane, bis(butylperoxy)cyclododecane, butyl bis(butylperoxy)valerate, dicumyl peroxide, butyl peroxy benzoate, dibutyl peroxide, bis(butylperoxy)diisopropylbenzene, dimethyldi(butylperoxy)hexane, dimethyldi(butylperoxy)hexyne and butylperoxycumene. The mixing amount of the peroxide (B) is required to be 0.01 to 10 parts by mass and is preferably 0.1 to 5 parts by mass in relation to 100 parts by mass of the polylactic acid resin (A) or in relation to 100 parts by mass of the total amount of the polylactic acid resin (A) and the plasticizer (D) (hereinafter, the mixture composed of the polylactic acid resin (A) and the plasticizer (D) is referred to as the “polylactic acid resin composition” as the case may be). Although the peroxide (B) can be used in an amount exceeding 10 parts by mass, the effect of the peroxide (B) is saturated, and such use is uneconomical. It is to be noted that such a peroxide is consumed through decomposition when mixed with the resin, and hence does not remain in the obtained resin composition as the case may be even when used at the time of mixing. The mixing of the peroxide results in the crosslinking of the polylactic acid resin component, and consequently improves the mechanical strength, the heat resistance and the dimensional stability of the obtained resin composition.

The silane compound (C), used in the present invention, having two or more functional groups selected form an alkoxy group, an acrylic group, a methacrylic group and a vinyl group is used as the crosslinking agent for the polylactic acid resin (A) and contributes to the increase of the crystallization rate of the polylactic acid resin (A), and is represented by the following formula (1):

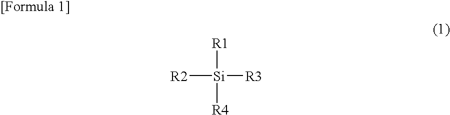

In formula (1), at least two or more of R1 to R4 represent the functional groups selected from an alkoxy group, an acrylic group, a methacrylic group and a vinyl group, or represent substituents having these functional groups. The rest of R1 to R4 represent groups other than an alkoxy group, a vinyl group or an acrylic group, and examples of such groups include a hydrogen atom, an alkyl group and an epoxy group. Examples of the alkoxy group include a methoxy group and an ethoxy group. Examples of the substituent having a vinyl group include a vinyl group and a p-styryl group. Examples of the substituent having an acrylic group include 3-methacryloxypropyl group and 3-acryloxypropyl group. Examples of the alkyl group include a methyl group and an ethyl group. Examples of the substituent having an epoxy group include 3-glycidoxypropyl group and a 2-(3,4-epoxycyclohexyl) group.

Specific examples and trade name examples of such a silane compound (C) include: tetramethoxysilane (TSL8114, manufactured by GE Toshiba Silicone Co., Ltd.; KBM-04, manufactured by Shin-Etsu Chemical Co., Ltd.), tetraethoxysilane (TSL8124, manufactured by GE Toshiba Silicone Co., Ltd.; KBE-04, manufactured by Shin-Etsu Chemical Co., Ltd.), methyltrimethoxysilane (TSL8113, manufactured by GE Toshiba Silicone Co., Ltd.; KBM-13, manufactured by Shin-Etsu Chemical Co., Ltd.), methyltriethoxysilane (TSL8123, manufactured by GE Toshiba Silicone Co., Ltd.; KBE-13, manufactured by Shin-Etsu Chemical Co., Ltd.), dimethyldimethoxysilane (TSL8112, manufactured by GE Toshiba Silicone Co., Ltd.), dimethyldiethoxysilane (TSL8122, manufactured by GE Toshiba Silicone Co., Ltd.; KBE-22, manufactured by Shin-Etsu Chemical Co., Ltd.), methyldimethoxysilane (TSL8117, manufactured by GE Toshiba Silicone Co., Ltd.), methyldiethoxysilane (TSL8127, manufactured by GE Toshiba Silicone Co., Ltd.), phenyltrimethoxysilane (TSL8173, manufactured by GE Toshiba Silicone Co., Ltd.), phenyltriethoxysilane (TSL8178, manufactured by GE Toshiba Silicone Co., Ltd.; KBE-103, manufactured by Shin-Etsu Chemical Co., Ltd.), diphenyldimethoxysilane (TSL8172, manufactured by GE Toshiba Silicone Co., Ltd.), diphenyldiethoxysilane (TSL8177, manufactured by GE Toshiba Silicone Co., Ltd.), hexyltrimethoxysilane (KBM-3063, manufactured by Shin-Etsu Chemical Co., Ltd.), decyltrimethoxysilane (KBM-3103C, manufactured by Shin-Etsu Chemical Co., Ltd.), 3-glycidoxypropyldimethoxymethylsilane (TSL-8355, manufactured by GE Toshiba Silicone Co., Ltd.), 3-glycidoxypropyltrimethoxysilane (TSL8350, manufactured by GE Toshiba Silicone Co., Ltd.; KBM-403, manufactured by Shin-Etsu Chemical Co., Ltd.), dimethylvinylmethoxysilane (TSL8317, manufactured by GE Toshiba Silicone Co., Ltd.), methylvinyldimethoxysilane (TSL8315, manufactured by GE Toshiba Silicone Co., Ltd.), methylvinyldiethoxysilane (TSL8316, manufactured by GE Toshiba Silicone Co., Ltd.), dimethylvinylethoxysilane (TSL8318, manufactured by GE Toshiba Silicone Co., Ltd.), vinyltrimethoxysilane (KBM-1003, manufactured by Shin-Etsu Chemical Co., Ltd.), vinyltriethoxysilane (TSL8311, manufactured by GE Toshiba Silicone Co., Ltd.; KBE-1003, manufactured by Shin-Etsu Chemical Co., Ltd.), 2-(3,4-epoxycyclohexyl)ethyltrimethoxysilane (KBM-303, manufactured by Shin-Etsu Chemical Co., Ltd.), 3-glycidoxypropylmethyldiethoxysilane (KBE-402, manufactured by Shin-Etsu Chemical Co., Ltd.), p-styryltrimethoxysilane (KBM-1403, manufactured by Shin-Etsu Chemical Co., Ltd.), 3-methacryloxypropylmethyldimethoxysilane (TSL8375, manufactured by GE Toshiba Silicone Co., Ltd.; KBM-502, manufactured by Shin-Etsu Chemical Co., Ltd.), 3-methacryloxypropyltrimethoxysilane (TSL8370, manufactured by GE Toshiba Silicone Co., Ltd.; KBM-503, manufactured by Shin-Etsu Chemical Co., Ltd.), 3-methacryloxypropylmethyldiethoxysilane (KBE-502, manufactured by Shin-Etsu Chemical Co., Ltd.), 3-methacryloxypropyltriethoxysilane (KBE-503, manufactured by Shin-Etsu Chemical Co., Ltd.), 3-acryloxypropyltrimethoxysilane (KBM-5103, manufactured by Shin-Etsu Chemical Co., Ltd.) and 3-acryloxypropylmethyldimethoxysilane (KBM-5102, manufactured by Shin-Etsu Chemical Co., Ltd.).

From the viewpoint of the improvement of the crystallization rate, preferable among these compounds are the silane compounds having one functional group selected from an acrylic group, a methacrylic group and a vinyl group and having three alkoxy groups. Specific examples and trade name examples of such silane compounds include: vinyltrimethoxysilane (KBM-1003, manufactured by Shin-Etsu Chemical Co., Ltd.), vinyltriethoxysilane (TSL8311, manufactured by GE Toshiba Silicone Co., Ltd.; KBE-1003, manufactured by Shin-Etsu Chemical Co., Ltd.), p-styryltrimethoxysilane (KBM-1403, manufactured by Shin-Etsu Chemical Co., Ltd.), 3-methacryloxypropyltrimethoxysilane (TSL8370, manufactured by GE Toshiba Silicone Co., Ltd.; KBM-503, manufactured by Shin-Etsu Chemical Co., Ltd.), 3-methacryloxypropyltriethoxysilane (KBE-503, manufactured by Shin-Etsu Chemical Co., Ltd.) and 3-acryloxypropyltrimethoxysilane (KBM-5103, manufactured by Shin-Etsu Chemical Co., Ltd.).

The mixing amount or the content of the silane compound (C) is required to be 0.01 to 5 parts by mass and is preferably 0.02 to 3 parts by mass and more preferably 0.05 to 1 part by mass in relation to 100 parts by mass of the polylactic acid resin (A) or in relation to 100 parts by mass of the above-described polylactic acid resin composition. When the mixing amount or the content of the silane compound (C) is less than 0.01 part by mass, no addition effect of the silane compound (C) is seen. Although the silane compound (C) can be used in an amount exceeding 5 parts by mass, the effect of the silane compound (C) is saturated, and such use is uneconomical.

As the crystal nucleating agent (E) used in the present invention, from the viewpoint of the crystallization promotion effect thereof, one or more selected from the following compounds may be quoted: an organic amide compound, an organic hydrazide compound, a carboxylic acid ester compound, an organic sulfonic acid salt, a phthalocyanine compound, a melamine compound and an organic phosphonic acid salt.

Examples of the organic amide compound and organic hydrazide compound, from the viewpoint of the effect as the organic crystal nucleating agent, include ethylene bisoleic acid amide, methylene bisacrylic acid amide, ethylene bisacrylic acid amide, hexamethylene bis-9,10-dihydroxystearic acid bisamide, p-xylylene bis-9,10-dihydroxystearic acid amide, decanedicarboxylic acid dibenzoylhydrazide, hexanedicarboxylic acid dibenzoylhydrazide, 1,4-cyclohexanedicarboxylic acid dicyclohexylamide, 2,6-naphthalenedicarboxylic acid dianilide, N,N′,N″-tricyclohexyl trimesic acid amide, trimesic acid tris(t-butylamide), 1,4-cyclohexanedicarboxylic acid dianilide, 2,6-naphthalenedicarboxylic acid dicyclohexylamide, N,N′-dibenzoyl-1,4-diaminocyclohexane, N,N′-dicyclohexanecarbonyl-1,5-diaminonaphthalene, ethylenebisstearic acid amide, N,N′-ethylenebis(12-hydroxystearic acid) amide and octanedicarboxylic acid dibenzoylhydrazide. From the viewpoints of the dispersibility in the resin and the heat resistance, preferable among these are N,N′,N″-tricyclohexyl trimesic acid amide, N,N′-ethylenebis(12-hydroxystearic acid) amide and octanedicarboxylic acid dibenzoylhydrazide.

Examples of the carboxylic acid ester compound include a monocarboxylic acid ester, an ethylene glycol monoester and an ethylene glycol diester, a glycerin monoester, a glycerin diester and glycerin triester; various carboxylic acid ester compounds can be used. Specific examples of the carboxylic acid ester compound include cetyl laurate, cetyl stearate, glycol monolaurate, glycol monostearate, glycol dilaurate, glycol dipalmitate, glycol distearate, glycerin monolaurate, glycerin monostearate, glycerin dilaurate, glycerin distearate, glycerin trilaurate and glycerin tristearate.

As the organic sulfonic acid salt, various salts such as sulfoisophthalic acid salt can be used. From the viewpoint of the crystallization promotion effect, preferable among these are metal salts of dimethyl 5-sulfoisophthalate; preferable are the barium salt, the calcium salt, the strontium salt, the potassium salt, the rubidium salt, the sodium salt and the like; and particularly preferable are potassium dimethyl 5-sulfoisophthalate and barium dimethyl 5-sulfoisophthalate.

As the phthalocyanine compound, various compounds can be used; however, transition metal complexes are preferably used, and preferable among these is copper phthalocyanine from the viewpoint of the crystallization promotion effect.

As the melamine compound, various compounds can be used; however, melamine cyanurate is preferably used from the viewpoint of the crystallization promotion effect.

As the organic phosphonic acid compound, preferable are the phenylphosphonic acid salts from the viewpoint of the crystallization promotion effect; particularly preferable among these is zinc phenylphosphonate.

As the crystal nucleating agent, these compounds may be mixed or contained each alone, or in combinations or as mixtures of two or more of these compounds.

These organic crystal nucleating agents may be used in combination with various inorganic crystal nucleating agents.

The mixing amount or the content of the crystal nucleating agent (E) is preferably 0.03 to 5 parts by mass and more preferably 0.1 to 4 parts by mass in relation to 100 parts by mass of the polylactic acid resin (A) or in relation to 100 parts by mass of the polylactic acid resin composition. When the mixing amount or the content of the crystal nucleating agent (E) is less than 0.03 part by mass, the addition or inclusion effect of the crystal nucleating agent (E) is poor. On the other hand, when the mixing amount or the content of the crystal nucleating agent (E) exceeds 5 parts by mass, the effect as the crystal nucleating agent (E) is saturated, and such use is economically disadvantageous, and is additionally unfavorable from the environmental viewpoint because of the increase of the residual after biodegradation.

Examples of the fibrous reinforcing material (F) used in the present invention include glass fiber, carbon fiber, alumina fiber, kenaf fiber, wollastonite, potassium titanate, cellulose fiber, metal fiber, metal whisker and ceramic whisker. In particular, inorganic fibrous reinforcing materials tend to contribute to the improvement of the strength and the rigidity. Conceivably, this is because the silane compound (C) and the fibrous reinforcing material (F) react with each other to enhance the adhesion of the inorganic reinforcing material with the resin. Glass fiber is preferable from the viewpoints of the heat rigidity, the strength and the economic efficiency, and more preferable is glass fiber having an oblate cross section from the viewpoint of the impact resistant strength.

A glass fiber having an oblate cross section is produced by a heretofore known method for producing glass fiber, and is sized with a sizing agent, and the sized glass fiber strands are collected and cut to a predetermined length to produce chopped strands, and thus, the glass fiber is used in the form of the chopped strands. The sizing agent includes at least one coupling agent such as a silane coupling agent, a titanium-based coupling agent or a zirconia-based coupling agent for the purpose of improving the adhesion with the matrix resin and uniform dispersibility, and includes an antistatic agent, a coating film forming agent and the like, and the sizing agent is appropriate to the resin with which the sizing agent is mixed. As such a sizing agent, heretofore known sizing agents may be used.

In the glass fiber having an oblate cross section, the major axis of the fiber cross section is preferably 10 to 50 μm, more preferably 15 to 40 μm and particularly preferably 20 to 35 μm. In the oblate cross section, the ratio of the major axis/minor axis is preferably 1.5 to 10 and more preferably 2.0 to 6.0. When the major axis/minor axis ratio is less than 1.5, the effect obtained by making the cross section oblate is small. A glass fiber having a major axis/minor axis ratio exceeding 10 has difficulty in producing itself. The ratio (aspect ratio) of the average fiber length to the average fiber diameter of the glass fiber is preferably 2 to 120, more preferably 2.5 to 70 and particularly preferably 3 to 50. When the ratio of the average fiber length to the average fiber diameter is less than 2, the improvement effect of the mechanical strength is small. When the ratio of the average fiber length to the average fiber diameter exceeds 120, the anisotropy comes to be large and additionally, the exterior appearance of the molded article is degraded. The average fiber diameter of the glass fiber having such an oblate cross section means the number average fiber diameter based on the perfect circles obtained by converting each of the oblate cross sections into the corresponding perfect circle having the same area as the area of the concerned oblate cross section. As a glass fiber having an oblate cross section, a fiber having the composition of a common glass such as E-glass is preferably used. However, any composition can be used as long as a glass fiber can be produced from the composition, and the glass composition is not particularly limited.

In the resin composition of the present invention, for the purpose of the strength improvement and the wet heat durability improvement, the polycarbodiimide compound (G) is preferably used in combination with the fibrous reinforcing material (F). The compounds other than the polycarbodiimide compound (G) such as an epoxy compound, an oxazoline compound and a monocarbodiimide compound are also generally effective for improving the wet heat durability of polylactic acid. However, as far as the present invention is concerned, these compounds are not so effective as the polycarbodiimide compound (G), with respect to the strength improvement and the wet heat durability improvement. However, when the polycarbodiimide compound (G) is used, additionally an epoxy compound, an oxazoline compound and a monocarbodiimide compound may also be used in combination with the polycarbodiimide compound (G).

The polycarbodiimide compound (G) used in the present invention is a compound having two or more carbodiimide groups in one molecule thereof. Examples of such a polycarbodiimide compound (G) include 1,5-naphthalene carbodiimide, 4,4′-diphenylmethane carbodiimide, 4,4′-diphenyldimethylmethane carbodiimide, 1,3-phenylene carbodiimide, 1,4-phenylene diisocyanate, 2,4-tolylene carbodiimide, 2,6-tolylene carbodiimide, a mixture composed of 2,4-tolylene carbodiimide and 2,6-tolylene carbodiimide, hexamethylene carbodiimide, cyclohexane-1,4-carbodiimide, xylylene carbodiimide, isophorone carbodiimide, dicyclohexylmethane-4,4′-carbodiimide, methylcyclohexane carbodiimide, tetramethylxylylene carbodiimide, 2,6-diisopropylphenylcarbodiimide and 1,3,5-triisopropylbenzene-2,4-carbodiimide.

Such carbodiimide compounds (G) can be produced by hitherto known methods, and can be produced by the carbodiimide reaction using a diisocyanate compound as a material and involving a carbon dioxide elimination reaction. The terminals of the molecule may have a remaining isocyanate group or may be blocked by a monoisocyanate.

Examples of the specific trade names of the polycarbodiimide compounds (G) include HMV-8CA and LA-1 manufactured by Nisshinbo Industries, Inc., and Stabaxol P and Stabaxol P100 manufactured by Rhein Chemie Corp.

The mixing amount or the content of the fibrous reinforcing material (F) and the mixing amount or the content of the polycarbodiimide compound (G) are preferably such that the fibrous reinforcing material (F) is contained in an amount of 60 to 10% by mass and the polycarbodiimide compound (G) is contained in an mount of 0.1 to 10% by mass in relation to the total amount of 39.9 to 89.9% by mass of the polylactic acid resin (A), the peroxide (B), the silane compound (C) and the plasticizer (D), with the proviso that the total amount is 100% by mass.

When the mixing amount or the content of the fibrous reinforcing material (F) is less than 10% by mass, the heat rigidity may be degraded, and when the mixing amount or the content of the fibrous reinforcing material (F) exceeds 60% by mass, problems associated with production may be caused. When the mixing amount or the content of the polycarbodiimide compound (G) is less than 0.1% by mass, the strength of the resin composition tends to be degraded, and when the mixing amount or the content of the polycarbodiimide compound (G) is larger than 10% by mass, the heat resistance of the resin composition may be degraded.

The thermoplastic resin composition of the present invention can be suitably used for electric product parts required to have both the flame retardation performance and the thin wall strength, by mixing the flame retardant (H) with the resin composition or by making the resin composition include the flame retardant (H).

Examples of the flame retardant (H) used in the present invention include phosphorus-based flame retardants, silicone-based flame retardants and inorganic flame retardants, and these flame retardants may be used in combinations of two or more thereof.

The mixing amount or the content of the flame retardant (H) is preferably 3 to 30% by mass in relation to the total amount of 36.9 to 89.9% by mass of the polylactic acid resin (A), the peroxide (B), the silane compound (C) and the plasticizer (D), and in relation to 0.1 to 10% by mass of the polycarbodiimide compound (G), with the proviso that the total amount is 100% by mass.

When the mixing amount or the content of the flame retardant (H) is less than 3% by mass, the flame retardant performance is almost not exhibited. On the other hand, when the mixing amount or the content of the flame retardant (H) exceeds 30% by mass, the strength of the resin composition tends to be degraded.

The flame retardant (H) is preferably a phosphinic acid metal salt, melamine polyphosphate, melamine cyanurate or a condensed phosphoric acid ester, particularly because of the high flame retardant effect thereof.

Specific examples of the trade name of melamine polyphosphate include: Melapur Series (Melapur 200/70) manufactured by Ciba Specialty Chemicals Inc.; MPP Series (MPP-A, MPP-B) manufactured by Nippon Carbide Industries Co., Ltd. (former company name: Sanwa Chemical Co., Ltd.); and PMP Series (PMP-100, PMP-200, PMP-300) manufactured by Nissan Chemical Industries, Ltd. Specific examples of the trade name of melamine cyanurate include: MC Series manufactured by Nissan Chemical Industries, Ltd.; and Melapur Series (Melapur MC-25) manufactured by Ciba Specialty Chemicals Inc. Specific examples of the trade name of the condensed phosphoric acid ester include: PX-200, PX-201, PX-202, CR-7335, CR-741 and CR-747 manufactured by Daihachi Chemical Industry Co., Ltd. Specific examples of the trade name of the phosphinic acid metal salt include: OP Series (OP930, OP935, OP1230, OP1312, OP1240 and the like) manufactured by Clariant Corp.

In the resin composition of the present invention, as long as the properties thereof are not significantly impaired, the following may be added: a pigment, a heat stabilizer, an antioxidant, a weather-resistant agent, a light resistant agent, a plasticizer, a lubricant, a release agent, an antistatic agent, a filler, a crystal nucleating agent and the like. Examples of the heat stabilizer and the antioxidant include hindered phenols, phosphorus compounds, hindered amines, sulfur compounds, copper compounds, alkali metal halides and vitamin E. Examples of the inorganic filler include talc, calcium carbonate, zinc carbonate, silica, alumina, magnesium oxide, calcium silicate, sodium aluminate, calcium aluminate, sodium aluminosilicate, magnesium silicate, glass balloon, carbon black, zinc oxide, antimony trioxide, zeolite, hydrotalcite, gold, boron nitride and graphite. Examples of the organic filler include naturally-occurring polymers such as starch, cellulose fine particles, wood powder, bean curd refuse, rice hull and bran; and the modified products of these. Examples of the inorganic crystal nucleating agents include talc and kaolin. Examples of the organic crystal nucleating agents include sorbitol compounds, benzoic acid and the metal salts of the compounds derived from benzoic acid, metal salts of phosphoric acid esters and rosin compounds.

Examples of the method for mixing with the polylactic acid resin (A) the following include a method for melt kneading by using a common extruder: the peroxide (B), the silane compound (C), the fibrous reinforcing material (F), the polycarbodiimide compound (G), the plasticizer (D), the flame retardant (H), the crystal nucleating agent (E) and other additives. The use of a double screw extruder is preferable in the sense that a satisfactory kneaded condition is to be attained. The kneading temperature preferably falls within a range from (the melting point of the polylactic acid resin (A)+5° C.) to (the melting point of the polylactic acid resin (A)+100° C.). The kneading time is preferably 20 seconds to 30 minutes. When the kneading temperature is lower than the above-described temperature range or the kneading time is shorter than the above-described time range, the kneading or the reaction may be insufficient. On the other hand, when the kneading temperature or the kneading time is respectively higher or longer than the corresponding range, the decomposition or the coloration of the resin may occur.

In the mixing, if possible, the polylactic acid resin (A), the plasticizer (D) and the crystal nucleating agent (E) are preferably added in the extruder from a top feeder of the extruder for the purpose of sufficiently compatibilizing or dispersing these components. The peroxide (B) is preferably added midway through kneading from the barrel of the extruder because the peroxide (B) is preferably allowed to react with the polylactic acid resin (A) when the polylactic acid resin (A) and the plasticizer (D) have already been sufficiently compatibilized with each other and the polylactic acid resin (A) is in a molten state. When the fibrous reinforcing material (F) is melt-kneaded together with the polylactic acid resin (A) and the plasticizer (D), the fibers of the fibrous reinforcing material (F) may be broken and the strength may be degraded. Therefore, similarly to the peroxide (B), the fibrous reinforcing material (F) is preferably added midway through kneading from the barrel of the extruder by side feeding or the like after the polylactic acid resin (A), the plasticizer (D) and the like have already been sufficiently melt-kneaded.

Preferable examples of the method for adding the peroxide (B) midway through kneading from the barrel include a method in which the peroxide (B) is dissolved or dispersed in a medium and then injected into a kneader. This way enables the operability to be remarkably improved. Specifically, while the polylactic acid resin (A), the plasticizer (D) and the crystal nucleating agent (E) are being melt-kneaded, the dissolved solution or the dispersion of the peroxide (B) is injected to be melt-kneaded together. The silane compound (C) may be added from the top feeder together with the polylactic acid resin (A), the plasticizer (D) and the crystal nucleating agent (E). When the silane compound (C) can be dissolved or dispersed in the dissolved solution or the dispersion of the peroxide (B), a method in which the silane compound (C) is added midway through kneading together with the peroxide (B) is also preferable with the proviso that no operational problems are caused.

As the medium for dissolving or dispersing the peroxide (B), common media can be used. Among such media, preferable is a plasticizer excellent in the compatibility with the polylactic acid resin (A). A plasticizer the same as or different from the plasticizer (D) used in the present invention may be used as long as the concerned plasticizer dissolves or uniformly disperses the peroxide (B). Alternatively, two or more plasticizers may also be used in combination. The mass ratio of the peroxide (B) to the medium, peroxide (B):medium, is preferably 1:0.5 to 1:20 and optimally 1:1 to 1:5.

The order of the addition of the peroxide (B) and the fibrous reinforcing material (F) into the extruder is described. The peroxide (B) is required to be reacted with the polylactic acid resin (A), and for the purpose of efficiently reacting the peroxide (B) with the polylactic acid resin (A), the peroxide (B) is required to be made to pass through the kneading screw section in the extruder. On the other hand, for the purpose of suppressing the breaking of the fibers, the fibrous reinforcing material (F) is preferably added downstream of the kneading screw section.

The order of the mixing of the polycarbodiimide compound (G) and the flame retardant (H) is not particularly limited; in consideration of the dispersibility, the reactivity and the thermal stability, a top feed addition method, a midway addition method or the like may be appropriately selected. Alternatively, resin composition pellets are prepared by melt-kneading the resin with the polycarbodiimide compound (G) and the flame retardant (H) mixed in high concentrations, and separately other resin composition pellets are prepared by melt-kneading the resin with the polycarbodiimide compound (G) and the flame retardant (H) mixed in low concentrations or by melt-kneading the resin without mixing the polycarbodiimide compound (G) and the flame retardant (H); and these plurality of types of pellets are mixed together so as for the individual components to finally fall within the ranges specified in the present invention, and thus the below-described injection molding or extrusion molding may be performed.

The resin composition of the present invention can be molded into various molded bodies by the molding methods such as injection molding, blow molding, extrusion molding and inflation molding, and by the molding methods, to be applied after processing into sheets, such as vacuum molding, pneumatic molding and vacuum-pneumatic molding. Among these, the injection molding method is preferably adopted. In addition to the common injection molding method, the molding methods such as gas injection molding and injection press molding can also be adopted. The injection molding conditions suitable for the resin composition of the present invention is appropriately such that the cylinder temperature is set within a range from 180 to 240° C. and more preferably within a range from 190 to 230° C. The die temperature is preferably 140° C. or lower. When the molding temperature is too low, the operability comes to be unstable in such a way that short shot occurs in the molded article, and overload tends to occur. On the other hand, when the molding temperature is too high, the resin composition is decomposed, and consequently the problems that the obtained molded body is degraded in strength and colored may occur.

The resin composition of the present invention can be enhanced in heat resistance by promoting the crystallization thereof. Examples of the method for that purpose include a method in which at the time of injection molding, cooling within the die promotes the crystallization. In this case, preferably the die temperature is maintained at a temperature of the crystallization temperature of the resin composition ±20° C. and the cooling is performed for a predetermined period of time. In consideration of the die releasability, further, after the die temperature has been decreased to the glass transition temperature of the resin composition or lower, then the die is opened and the molded article may be taken out. As the method for promoting the crystallization after the molding, the molded article is preferably heat treated again at a temperature of the crystallization temperature ±20° C. When a plurality of crystallization temperatures are involved, the same treatment may be performed at each of the plurality of crystallization temperatures, or a crystallization temperature at which the heat resistance is most enhanced may be selected. When a plurality of glass transition temperatures are involved, a glass transition temperature free from the problems associated with the molding may be selected.

Specific examples of the molded articles include: resin components for the electric appliances such as various enclosures for personal computers, printers, projector lamps and the like; and resin components for vehicles such as bumpers, inner panels and door trims. Additionally, molded articles such as films, sheets and hollow molded articles can also be obtained.

### EXAMPLES

Hereinafter, the present invention is described more specifically with reference to Examples. However, the present invention is not limited to below-described Examples.

1. Evaluation Items

(1) Melt Flow Rate (MFR)

The melt flow rate was measured according to ISO Standard 1133 at 190° C. under a load of 21.2 N.

(2) Deflection Temperature Under Load (DTUL)

The deflection temperature under load was measured according to ISO Standards 75-1 and -2 for Examples 1 to 15 and Comparative Examples 1 to 4 under a load of 0.45 MPa and for Examples 16 to 37 and Comparative Examples 5 to 15 under a load of 1.8 MPa. For practical applications, the deflection temperature under load is preferably 80° C. or higher.

(3) Molding Cycle

With an injection molding machine (IS-80G, manufactured by Toshiba Machine Co., Ltd.), a molding test of a dumbbell-type specimen was performed. Under the conditions of a molding temperature set at 190° C. and a die temperature of 100° C., the cooling time elapsed after the filling of a resin into the die was gradually extended, and thus the molding cycle which provided a satisfactory release from the die was evaluated. It may be noted that when the release from the die was not made satisfactory even in 60 seconds, the evaluation was not performed for the elapsed time of 60 seconds or more. The cooling time is preferably 40 seconds or less from the viewpoint of economic efficiency.

(4) Flexural Strength

The flexural strength was measured according to ISO Standard 178. For practical applications, the flexural strength is preferably 180 MPa or more.

(5) Flexural Modulus

The flexural modulus was measured according to ISO Standard 178. For practical applications, the flexural modulus is preferably 9.0 GPa or more.

(6) Flame Retardancy

The flame retardancy was measured according to the vertical combustion test method of UL94 (Standard established by Under Writers Laboratories Inc., United States). It is to be noted that the thickness of a specimen was set at 1/16 inch (about 1.6 mm). The flame retardancy is preferably V-2, V-1 or V-0, and particularly preferably V-1 or V-0.

2. Materials

(1) Polylactic Acid Resin

NatureWorks 3001D manufactured by Cargill Dow LLC; MFR: 10 g/10 min; melting point: 168° C. (hereinafter abbreviated as “PLA”).

(2) Polybutylene Succinate Resin

GS-Pla AZ-71T manufactured by Mitsubishi Chemical Corp.; MFR: 20 g/10 min (hereinafter abbreviated as “PBS”).

(3a) Plasticizer

Glycerin diacetomonocaprate, PL-019 manufactured by Riken Vitamin Co., Ltd.

(3b) Plasticizer

Medium chain fatty acid triglyceride, Actor-M-1 manufactured by Riken Vitamin Co., Ltd.

(3c) Plasticizer

Polyglycerin fatty acid ester, Chirabazol VR-01 manufactured by Taiyo Kagaku Co., Ltd.

(3d) Plasticizer

Acetyl tributylcitrate, ATBC manufactured by Taoka Chemical Co., Ltd.

(3e) Plasticizer

Trinormaloctyl trimellitate, Trimex N-08 manufactured by Kao Corp.

(4) Peroxide

Di-t-butyl peroxide, Perbutyl D manufactured by NOF Corp.

(5a) Silane Compound

Vinyltrimethoxysilane, KBM-1003 manufactured by Shin-Etsu Chemical Co., Ltd. (hereinafter abbreviated as “S1”)

(5b) Silane Compound

3-acryloxypropyldimethoxysilane (KBM-5102, manufactured by Shin-Etsu Chemical Co., Ltd. (hereinafter abbreviated as “S2”)

(5c) Silane Compound

p-Styryltrimethoxysilane, KBM-1403 manufactured by Shin-Etsu Chemical Co., Ltd. (hereinafter abbreviated as “S3”)

(5d) Silane Compound

3-Methacryloxypropyltrimethoxysilane, TSL8370 manufactured by GE Toshiba Silicone Co., Ltd. (hereinafter abbreviated as “S4”)

(6) Acrylic Acid Ester Compound (Crosslinking Aid)

Ethylene glycol dimethacrylate, Blenmer PDE-50 manufactured by NOF Corp.

(7a) Polycarbodiimide Compound

LA-1 manufactured by Nisshinbo Industries, Inc. (hereinafter abbreviated as “CC1”)

(7b) Polycarbodiimide Compound

Stabaxol P manufactured by Rhein Chemie Corp. (hereinafter abbreviated as “CC2”)

(7c) Monocarbodiimide Compound

Stabaxol I manufactured by Rhein Chemie Corp. (hereinafter abbreviated as “CC3”)

(7d) Epoxy Compound

Phenyl glycidyl ether, Denacol EX-141 manufactured by Nagase Kasei Kogyo Co., Ltd. (hereinafter abbreviated as “EC”)

(8a) Glass Fiber Having a Circular Cross Section

03JFAT592 manufactured by Owens Corning Corp.; fiber diameter: φ10 μm, fiber length: 3 mm (hereinafter abbreviated as “GF1”)

(8b) Glass Fiber Having an Oblate Cross Section

CSG3PA820S manufactured by Nitto Boseki Co., Ltd., a flat glass fiber having an oblate cross section with a major axis of 28 μm, a minor axis of 7 μm and a ratio of the major axis to the minor axis of 4.0, and having a fiber length of 3 mm (hereinafter abbreviated as “GF2”)

(8c) Kenaf Fiber

A kenaf fiber prepared by cutting a sample of kenaf to a constant length of about 5 mm, and by crushing and disentangling the cut sample with a turbo mill (T-250, manufactured by Matsubo Corp.) so as to have a fiber diameter of 20 to 50 μm and a fiber length of 1 to 5 mm (hereinafter abbreviated as “KF”)

(9a) Flame Retardant

Phosphinic acid metal salt, Exolit OP935 manufactured by Clariant Corp. (hereinafter abbreviated as “FR1”)

(9b) Flame Retardant

Condensed phosphoric acid ester, resorcinol bis(dixylenyl phosphate), PX-200 manufactured by Daihachi Chemical Industry Co., Ltd. (hereinafter abbreviated as “FR2”)

(10a) Organic Crystal Nucleating Agent

N,N′,N″-Tricyclohexyl trimesic acid amide, TF-1 manufactured by New Japan Chemical Co., Ltd. (hereinafter abbreviated as “CN”)

(10b) Organic Crystal Nucleating Agent

Potassium dimethyl 5-sulfoisophthalate manufactured by Takemoto Oil & Fat Co., Ltd. (hereinafter abbreviated as “5S-IPA”)

(10c) Organic Crystal Nucleating Agent

Barium dimethyl 5-sulfoisophthalate manufactured by Takemoto Oil & Fat Co., Ltd. (hereinafter abbreviated as “5S-IPB”)

### Examples 1 to 15 and Comparative Examples 1 to 4

In each of Examples 1 to 15 and Comparative Examples 1 to 4, by using a double screw extruder (TEM-37BS, manufactured by Toshiba Machine Co., Ltd.), according to the mixing proportions shown in Table 1 under the heading of the top feed composition, a polylactic acid resin (A), a plasticizer (D) and a crystal nucleating agent (E) were fed from a top feeder, and a melt-kneading extrusion was performed at a processing temperature of 190° C. In this case, at a midway position in the extruder, by using a pump, a mixed solution of a peroxide (B) and a crosslinking aid was injected with the mixing proportions shown in Table 1 under the heading of the midway addition composition; then, the discharged resin was cut into a pellet shape to yield a resin composition.

Next, in each of Examples 1 to 15 and Comparative Examples 1 to 4, by using pellets subjected to a drying treatment at 70° C. for 8 hours with a vacuum dryer, a molding test of a dumbbell specimen was performed with an injection molding machine (IS-80G, manufactured by Toshiba Machine Co., Ltd.), and thus the molding cycle that varied on the basis of the magnitude of the crystallization rate was evaluated. Additionally, by using a specimen having a molding cycle of 60 seconds, the deflection temperature under load was measured. The results obtained by evaluating various physical properties are collected in Table 1.

TABLE 1

| | | | | Examples | | | | | | | | | |
|---|---|---|---|---|---|---|---|---|---|---|---|---|---|
| | | | | 1 | 2 | 3 | 4 | 5 | 6 | 7 | 8 | 9 | 10 |
| Top feed | Polylactic acid resins | | PLA | 100 | 100 | 100 | 100 | 100 | 100 | 90 | 99 | 95 | 95 |
| composition | (A) | | PBS | | | | | | | 10 | | | |
| (parts by | Plasticizers (D) | | PL- | | | | | | | | 1 | 5 | |
| mass) | | | 019 | | | | | | | | | | |
| | | | ATBC | | | | | | | | | | 5 |
| | | | N-08 | | | | | | | | | | |
| | | | M-1 | | | | | | | | | | |
| | | | VR- | | | | | | | | | | |
| | | | 01 | | | | | | | | | | |
| | Crystal nucleating | | TF-1 | | | | | | | | | | |
| | agents (E) | | 5S- | | | | | | | | | | |
| | | | IPA | | | | | | | | | | |
| Midway | Peroxide (B) | | | 0.4 | 0.4 | 0.4 | 0.4 | 0.1 | 6 | 0.4 | 0.4 | 0.4 | 0.4 |
| addition | Crosslinking | Silane | S1 | 0.2 | | | | 0.05 | 3 | 0.2 | 0.2 | 0.2 | 0.2 |
| composition | aids | compounds | S2 | | 0.2 | | | | | | | | |
| (parts by | | (C) | S3 | | | 0.2 | | | | | | | |
| mass) | | | S4 | | | | 0.2 | | | | | | |

Acrylic acid
ester compound

| | | | | | | | | | | | |
|---|---|---|---|---|---|---|---|---|---|---|---|
| Medium | PL- | 2 | 2 | 2 | 2 | 0.5 | 6 | 2 | 2 | 2 | 0.5 |
| | 019 | | | | | | | | | | |

| | | | | | | | | | | | |
|---|---|---|---|---|---|---|---|---|---|---|---|
| Evaluation | Deflection temperature under | 115 | 114 | 116 | 113 | 111 | 118 | 84 | 110 | 94 | 96 |
| | load (0.45 MPa) (° C.) | | | | | | | | | | |
| | Molding cycle (sec) | 25 | 40 | 30 | 35 | 30 | 25 | 40 | 25 | 20 | 25 |

| | | | | | | | | Comparative | | | |
|---|---|---|---|---|---|---|---|---|---|---|---|
| | | | Examples | | | | | Examples | | | |
| | | | 11 | 12 | 13 | 14 | 15 | 1 | 2 | 3 | 4 |
| Top feed | Polylactic acid resins | PLA | 95 | 95 | 95 | 100 | 100 | 80 | 100 | 100 | 100 |
| composition | (A) | PBS | | | | | | | | | |
| (parts by | Plasticizers (D) | PL- | | | | | | 20 | | | |
| mass) | | 019 | | | | | | | | | |
| | | ATBC | | | | | | | | | |
| | | N-08 | 5 | | | | | | | | |
| | | M-1 | | 5 | | | | | | | |
| | | VR- | | | 5 | | | | | | |
| | | 01 | | | | | | | | | |
| | Crystal nucleating | TF-1 | | | | 0.5 | | | | | |
| | agents (E) | 5S- | | | | | 2 | | | | |
| | | IPA | | | | | | | | | |

| | | | | | | | | | |
|---|---|---|---|---|---|---|---|---|---|
| Midway | Peroxide (B) | 0.4 | 0.4 | 0.4 | 0.4 | 0.4 | 0.4 | 0.4 | 1.6 |

| | | | | | | | | | | |
|---|---|---|---|---|---|---|---|---|---|---|
| addition | Crosslinking | Silane | S1 | 0.2 | 0.2 | 0.2 | 0.2 | 0.2 | 0.2 | 0.5 |
| composition | aids | compounds | S2 | | | | | | | |
| (parts by | | (C) | S3 | | | | | | | |
| mass) | | | S4 | | | | | | | |

| | |
|---|---|
| Acrylic acid | 0.2 |
| ester compound | |

| | | | | | | | | | |
|---|---|---|---|---|---|---|---|---|---|
| Medium | PL- | 0.5 | 0.5 | 0.5 | 0.5 | 0.5 | 2 | 2 | 8 |
| | 019 | | | | | | | | |

| | | | | | | | | | | |
|---|---|---|---|---|---|---|---|---|---|---|
| Evaluation | Deflection temperature under | 98 | 97 | 95 | 117 | 120 | 75 | 65 | 53 | 54 |
| | load (0.45 MPa) (° C.) | | | | | | | | | |
| | Molding cycle (sec) | 25 | 20 | 30 | 20 | 15 | 25 | >60 | >60 | >60 |

In each of Examples 1 to 15, the values of both of the deflection temperature under load and the molding cycle were satisfactory. On the contrary, in Comparative Example 1, the proportion of the plasticizer was too large, and consequently the deflection temperature under load was low. In each of Examples 2 and 3, no silane compound was used as the crosslinking aid, and consequently the molding cycle was long and the deflection temperature under load was low. Further, in Comparative Example 4, no peroxide was added, and consequently the deflection temperature under load was low, the molding cycle was 100 seconds to result in an unsatisfactory release from the die and the deflection temperature under load was low.

### Examples 16 to 37

In each of Examples 16 to 37, by using a double screw extruder (TEM 26SS, manufactured by Toshiba Machine Co., Ltd.), according to the mixing proportions shown in Table 2 or 3 under the heading of the top feed composition, a polylactic acid resin, a carbodiimide compound, a plasticizer in the case where the plasticizer was used and a crystal nucleating agent in the case where the crystal nucleating agent was used were fed from the top feeder, and a melt-kneading extrusion was performed at a processing temperature of 190° C. In this case, at a midway position in the extruder, by using a pump, a mixed solution of a silane compound/a peroxide/a (or the) plasticizer (used as solvent) was injected with the mixing proportions shown in Table 2 or 3 under the heading of the midway addition composition 1. Further, at a further downstream position, according to the mixing proportions shown in Table 2 or 3 under the heading of the midway addition composition 2, a fibrous reinforcing material and a flame retardant or flame retardants in the case where the flame retardant or the flame retardants were used were fed by side feeding; then, the discharged resin was cut into a pellet shape to yield a resin composition.

Next, in each of Examples 16 to 37, by using pellets subjected to a drying treatment with a vacuum dryer at 80° C. for 8 hours, a molding test of a dumbbell specimen was performed with an injection molding machine (IS-80G, manufactured by Toshiba Machine Co., Ltd.), and thus the molding cycle was evaluated. Additionally, by using a specimen having a molding cycle of 60 seconds, the deflection temperature under load, the flexural strength and the flexural modulus were measured.

In each of Examples 31, 32 and 33 in each of which the flame retardant or the flame retardants were mixed, a 1.6-mm thick UL specimen was prepared with the injection molding machine (IS-80G, manufactured by Toshiba Machine Co., Ltd.), and the UL combustion test was performed.

The results thus obtained are shown in Tables 2 or 3.

TABLE 2

| | | | | Examples | | | | | | | | |
|---|---|---|---|---|---|---|---|---|---|---|---|---|
| | | | | 16 | 17 | 18 | 19 | 20 | 21 | 22 | 23 | 24 |
| Top feed | Polylactic acid resins | | PLA | 67.6 | 82.4 | 67.6 | 48.0 | 57.8 | 68.0 | 67.6 | 67.6 | 67.6 |
| composition | (A) | | PBS | | | | | | | | | |
| (parts by | Plasticizers (D) | | PL- | | | | | | | | | |
| mass) | | | 109 | | | | | | | | | |
| | | | M-1 | | | | | | | | | |
| | | | VR- | | | | | | | | | |
| | | | 01 | | | | | | | | | |
| | | | ATBC | | | | | | | | | |
| | Crystal nucleating | | TF-1 | 0.34 | 0.41 | 0.34 | 0.24 | 0.29 | | 0.34 | 0.34 | 0.34 |
| | agents (E) | | 5S- | | | | | | | | | |
| | | | IPB | | | | | | | | | |
| | Polycarbodiimide | | CC1 | 1 | 1 | 1 | 1 | 1 | 1 | 1 | 1 | 1 |
| | compounds (G) | | CC2 | | | | | | | | | |
| | Monocarbodiimide | | CC3 | | | | | | | | | |
| | compound | | | | | | | | | | | |
| | Epoxy compound | | EC | | | | | | | | | |
| Midway | Peroxide (B) | | | 0.20 | 0.25 | 0.20 | 0.14 | 0.17 | 0.20 | 0.20 | 0.20 | 0.20 |
| addition | Crosslinking | Silane | S1 | 0.10 | 0.12 | 0.10 | 0.07 | 0.09 | 0.10 | | | |
| composition | aids | compounds | S2 | | | | | | | 0.10 | | |
| 1 (parts by | | (C) | S3 | | | | | | | | 0.10 | |
| mass) | | | S4 | | | | | | | | | 0.10 |

Acrylic acid
ester compound

| | | | | | | | | | | | |
|---|---|---|---|---|---|---|---|---|---|---|---|
| | Medium | PL- | 0.71 | 0.86 | 0.71 | 0.50 | 0.61 | 0.71 | 0.71 | 0.71 | 0.71 |
| | | 019 | | | | | | | | | |
| Midway | Fibrous reinforcing | GF1 | 30 | | | | | | | | |
| addition | materials (F) | GF2 | | 15 | 30 | 50 | | 30 | 30 | 30 | 30 |
| composition | | KF | | | | | 40 | | | | |
| 2 (parts by | Flame retardants (H) | FR1 | | | | | | | | | |
| mass) | | FR2 | | | | | | | | | |

| | | | | | | | | | | |
|---|---|---|---|---|---|---|---|---|---|---|
| Evaluation | Deflection temperature under | 148 | 140 | 155 | 156 | 92 | 152 | 154 | 153 | 154 |
| | load (1.8 MPa) (° C.) | | | | | | | | | |
| | Molding cycle (sec) | 35 | 35 | 35 | 35 | 35 | 40 | 35 | 35 | 35 |
| | Flexural strength (MPa) | 210 | 180 | 220 | 245 | 205 | 215 | 218 | 216 | 216 |
| | Flexural modulus (GPa) | 10.5 | 9.5 | 12.5 | 19.5 | 10.1 | 12.2 | 12.3 | 12.3 | 12.4 |
| | Flame retardancy | — | — | — | — | — | — | — | — | — |

TABLE 3

| | | | Examples | | | | | | |
|---|---|---|---|---|---|---|---|---|---|
| | | | 25 | 26 | 27 | 28 | 29 | 30 | 31 |
| Top feed | Polylactic acid | PLA | 65.6 | 65.6 | 65.6 | 65.6 | 67.6 | 44.0 | 32.4 |
| composition | resins (A) | PBS | | | | | | 4.1 | |
| (parts by | Plasticizers (D) | PL-109 | 2.0 | | | | | | |
| mass) | | M-1 | | 2.0 | | | | | |
| | | VR-01 | | | 2.0 | | | | |
| | | ATBC | | | | 2.0 | | | |
| | Crystal nucleating | TF-1 | 0.34 | 0.34 | 0.34 | 0.34 | 0.34 | 0.24 | 0.16 |
| | agents (E) | 5S-IPB | | | | | | | |
| | Polycarbodiimide | CC1 | 1 | 1 | 1 | 1 | | 1 | 2 |
| | compounds (G) | CC2 | | | | | 1 | | |
| | Monocarbodiimide | CC3 | | | | | | | |
| | compound | | | | | | | | |
| | Epoxy compound | EC | | | | | | | |

| Midway | Peroxide (B) | | | 0.20 | 0.20 | 0.20 | 0.20 | 0.20 | 0.14 | 0.10 |
|---|---|---|---|---|---|---|---|---|---|---|
| addition | Crosslinking | Silane | S1 | 0.10 | 0.10 | 0.10 | 0.10 | 0.10 | 0.07 | 0.05 |
| composition | aids | compounds | S2 | | | | | | | |
| 1 (parts by | | (C) | S3 | | | | | | | |
| mass) | | | S4 | | | | | | | |

Acrylic acid
ester
compound

| | | | | | | | | | |
|---|---|---|---|---|---|---|---|---|---|
| | Medium | PL-019 | 0.71 | 0.71 | 0.71 | 0.71 | 0.71 | 0.50 | 0.34 |
| Midway | Fibrous reinforcing | GF1 | | | | | | | |
| addition | materials (F) | GF2 | 30 | 30 | 30 | 30 | 30 | 50 | 50 |
| composition | | KF | | | | | | | |
| 2 (parts by | Flame retardants (H) | FR1 | | | | | | | 15 |
| mass) | | FR2 | | | | | | | |

| | | | | | | | | |
|---|---|---|---|---|---|---|---|---|
| Evaluation | Deflection temperature under | 146 | 146 | 145 | 148 | 152 | 141 | 155 |
| | load (1.8 MPa) (° C.) | | | | | | | |
| | Molding cycle (sec) | 30 | 30 | 30 | 30 | 30 | 30 | 30 |
| | Flexural strength (MPa) | 208 | 205 | 206 | 208 | 213 | 201 | 227 |
| | Flexural modulus (GPa) | 10.5 | 10.5 | 10.6 | 10.7 | 12.2 | 11.1 | 19.3 |
| | Flame retardancy | — | — | — | — | — | — | V-1 |

| | | | Examples | | | | | |
|---|---|---|---|---|---|---|---|---|
| | | | 32 | 33 | 34 | 35 | 36 | 37 |
| Top feed | Polylactic acid | PLA | 31.4 | 26.5 | 67.6 | 60.9 | 68.4 | 57.3 |
| composition | resins (A) | PBS | | | | | | |
| (parts by | Plasticizers (D) | PL-109 | | | | | | |
| mass) | | M-1 | | | | 6.8 | | |
| | | VR-01 | | | | | | |
| | | ATBC | | | | | | |
| | Crystal nucleating | TF-1 | 0.16 | 0.13 | | 0.34 | 0.34 | 0.29 |
| | agents (E) | 5S-IPB | | | 0.34 | | | |
| | Polycarbodiimide | CC1 | 2 | 2 | 1 | 1 | 1 | 1 |
| | compounds (G) | CC2 | | | | | | |
| | Monocarbodiimide | CC3 | 1 | 1 | | | | |
| | compound | | | | | | | |
| | Epoxy compound | EC | | | | | | |

| Midway | Peroxide (B) | | | 0.09 | 0.08 | 0.20 | 0.20 | 0.03 | 5.73 |
|---|---|---|---|---|---|---|---|---|---|
| addition | Crosslinking | Silane | S1 | 0.05 | 0.04 | 0.10 | 0.10 | 0.03 | 2.86 |
| composition | aids | compounds | S2 | | | | | | |
| 1 (parts by | | (C) | S3 | | | | | | |
| mass) | | | S4 | | | | | | |

Acrylic acid
ester
compound

| | | | | | | | | |
|---|---|---|---|---|---|---|---|---|
| | Medium | PL-019 | 0.33 | 0.28 | 0.71 | 0.71 | 0.24 | 2.86 |
| Midway | Fibrous reinforcing | GF1 | | | 30 | | | |
| addition | materials (F) | GF2 | 50 | 50 | | 30 | 30 | 30 |
| composition | | KF | | | | | | |
| 2 (parts by | Flame retardants (H) | FR1 | 15 | 10 | | | | |
| mass) | | FR2 | | 10 | | | | |

| | | | | | | | |
|---|---|---|---|---|---|---|---|
| Evaluation | Deflection temperature under | 154 | 132 | 148 | 144 | 147 | 151 |
| | load (1.8 MPa) (° C.) | | | | | | |
| | Molding cycle (sec) | 30 | 35 | 35 | 25 | 40 | 25 |
| | Flexural strength (MPa) | 225 | 203 | 212 | 192 | 209 | 215 |
| | Flexural modulus (GPa) | 19.2 | 17.4 | 10.1 | 10.2 | 10.3 | 10.8 |
| | Flame retardancy | V-1 | V-1 | — | — | — | — |

### Comparative Examples 5 to 15

In each of Comparative Examples 5 to 15, by using a double screw extruder (TEM 26SS, manufactured by Toshiba Machine Co., Ltd.), according to the mixing proportions shown in Table 4 under the heading of the top feed composition, a polylactic acid resin, a carbodiimide compound, a plasticizer in the case where the plasticizer was used and a crystal nucleating agent in the case where the crystal nucleating agent was used were fed from a top feeder, and a melt-kneading extrusion was performed at a processing temperature of 190° C. In this case, at a midway position in the extruder, by using a pump, a mixed solution of a silane compound/a peroxide/a plasticizer (used as solvent) was injected with the mixing proportions shown in Table 4 under the heading of the midway addition composition 1. Further, at a further downstream position, according to the mixing proportions shown in Table 4 under the heading of the midway addition composition 2, a fibrous reinforcing material and a flame retardant in the case where the flame retardant was used were fed by side feeding; then, the discharged resin was cut into a pellet shape to yield a resin composition.

It is to be noted that in Comparative Example 11, the mixing amount of the glass fiber was too large, and hence strands were broken into pieces and hence pelletization was unsuccessful.

Next, in each of Comparative Examples 5 to 10 and 12 to 15, by using pellets subjected to a drying treatment with a vacuum dryer at 80° C. for 8 hours, a molding test of a dumbbell specimen was performed with an injection molding machine (IS-80G, manufactured by Toshiba Machine Co., Ltd.), and thus the molding cycle was evaluated. Additionally, by using a specimen having a molding cycle of 60 seconds, the deflection temperature under load, the flexural strength and the flexural modulus were measured.

The results obtained by evaluating various physical properties are collected in Table 4.

TABLE 4

| | | | | Comparative Examples | | | | | | | | | | |
|---|---|---|---|---|---|---|---|---|---|---|---|---|---|---|
| | | | | 5 | 6 | 7 | 8 | 9 | 10 | 11 | 12 | 13 | 14 | 15 |
| Top feed | Polylactic acid | | PLA | 68.1 | 68.2 | 69.0 | 68.0 | 68.0 | 87.7 | 28.6 | 68.0 | 54.1 | 53.9 | 31.4 |
| composition | resins (A) | | PBS | | | | | | | | | | | |
| (parts by mass) | Plasticizers (D) | | PL-109 | | | | | | | | | | | |
| | | | M-1 | | | | | | | | | 13.5 | | |
| | | | VR-01 | | | | | | | | | | | |
| | | | ATBC | | | | | | | | | | | |
| | Crystal nucleating | | TF-1 | | | | | | | | | 0.34 | 0.27 | 0.16 |
| | agents (E) | | 5S-IPB | | | | | | | | | | | |
| | Polycarbodiimide | | CC1 | 1 | 1 | | | | 1 | 1 | 1 | 1 | 15 | 2 |
| | compounds (G) | | CC2 | | | | | | | | | | | |
| | Monocarbodiimide | | CC3 | | | | 1 | | | | | | | 1 |
| | compound | | | | | | | | | | | | | |
| | Epoxy compound | | EC | | | | | 1 | | | | | | |
| Midway | Peroxide (B) | | | 0.20 | | 0.21 | 0.20 | 0.20 | 0.26 | 0.09 | 0.20 | 0.20 | 0.16 | 0.09 |
| addition | Cross- | Silane | S1 | | 0.10 | 0.10 | 0.10 | 0.10 | 0.13 | 0.04 | | 0.10 | 0.08 | 0.05 |
| composition 1 | linking | com- | S2 | | | | | | | | | | | |
| (parts by mass) | aids | pounds | S3 | | | | | | | | | | | |
| | | (C) | S4 | | | | | | | | | | | |

| | |
|---|---|
| Acrylic acid | 0.10 |
| ester | |
| compound | |

| | | | | | | | | | | | | | |
|---|---|---|---|---|---|---|---|---|---|---|---|---|---|
| | Medium | PL-019 | 0.71 | 0.72 | 0.72 | 0.71 | 0.71 | 0.92 | 0.30 | 0.71 | 0.71 | 0.57 | 0.33 |
| Midway | Fibrous reinforcing | GF1 | | | | | | | | | | 30 | |
| addition | materials (F) | GF2 | 30 | 30 | 30 | 30 | 30 | 10 | 70 | 30 | 30 | | 30 |
| composition 2 | | KF | | | | | | | | | | | |
| (parts by mass) | Flame retardants (H) | FR1 | | | | | | | | | | | 35 |
| | | FR2 | | | | | | | | | | | |

| | | | | | | | | | | | | |
|---|---|---|---|---|---|---|---|---|---|---|---|---|
| Evaluation | Deflection temperature under | 95 | 53 | 142 | 135 | 138 | 91 | — | 155 | 139 | 78 | 150 |
| | load (1.8 MPa) (° C.) | | | | | | | | | | | |
| | Molding cycle (sec) | >60 | >60 | 35 | 35 | 35 | 35 | — | 50 | 20 | 45 | 40 |
| | Flexural strength (MPa) | 185 | 172 | 175 | 168 | 170 | 138 | — | 222 | 175 | 225 | 155 |
| | Flexural modulus (GPa) | 11 | 10.9 | 11.2 | 10.8 | 10.9 | 7.1 | — | 11.6 | 8.9 | 11.7 | 10.6 |
| | Flame retardancy | — | — | — | — | — | — | — | — | — | — | V-0 |

In each of Examples 16 to 37, the deflection temperature under load, the molding cooling time, the flexural strength and the flexural modulus all exhibited satisfactory values.

In each of Comparative Examples 5 and 12, no silane compound was mixed, and hence the molding cycle was too long.

In Comparative Example 6, no peroxide was mixed, and hence the molding cooling time was long and the deflection temperature under load was low, and additionally the flexural strength was low.

In each of Comparative Examples 7 to 9, no polycarbodiimide compound was used, and hence the flexural strength was low.

In Comparative Example 10, the mixing amount of the glass fiber was too small, and hence the improvement degree of the flexural strength and the improvement degree of the flexural modulus, due to the mixing of the glass fiber, were low.

In Comparative Example 11, the mixing amount of the glass fiber was too large as described above, and hence the resin strands discharged from the nozzles of the extruder were broken into pieces so as to preclude the pellet sampling of the resin and the operability was poor.

In Comparative Example 13, the mixing amount of the plasticizer was too large, and hence the flexural strength and the flexural modulus were low.

In Comparative Example 14, the mixing amount of the polycarbodiimide was too large, and hence the heat resistance was degraded and the molding cooling time was long.

In Comparative Example 15, the mixing amount of the flame retardant was too large, and hence the flexural strength was low.

1. A thermoplastic resin composition, wherein the thermoplastic resin composition is obtained by mixing together 100 parts by mass of a polylactic acid resin or a polylactic acid resin composition, 0.01 to 10 parts by mass of a peroxide and 0.01 to 5 parts by mass of a silane compound having two or more functional groups selected from an alkoxy group, an acrylic group, a methacrylic group and a vinyl group.

2. The thermoplastic resin composition according to claim 1, wherein the polylactic acid resin composition comprises 90 to 99.5% by mass of the polylactic acid resin and 0.5 to 10% by mass of a plasticizer.

3. The thermoplastic resin composition according to claim 2, wherein the plasticizer is one or more selected from an aliphatic polycarboxylic acid ester derivative, an aliphatic polyhydric alcohol ester derivative, an aliphatic oxyester derivative, an aliphatic polyether derivative and an aliphatic polyether polycarboxylic acid ester derivative.

4. The thermoplastic resin composition according to claim 1, further comprising as a crystal nucleating agent one or more selected from an organic amide compound, an organic hydrazide compound, a carboxylic acid ester compound, an organic sulfonic acid salt, a phthalocyanine compound, a melamine compound and an organic phosphonic acid salt.

5. The thermoplastic resin composition according to claim 4, wherein the crystal nucleating agent is one or more selected from a metal salt of dimethyl 5-sulfoisophthalate, N,N′,N″-tricyclohexyl trimesic acid amide, N,N′-ethylenebis(12-hydroxystearic acid) amide and octanedicarboxylic acid dibenzoyl hydrazide.

6. The thermoplastic resin composition according to claim 1, wherein the polylactic acid resin is mainly composed of polylactic acid.

7. The thermoplastic resin composition according to claim 1, wherein the polylactic acid resin is produced from a plant material.

8. A thermoplastic resin composition comprising 39.9 to 89.9% by mass of the thermoplastic resin composition according to claims 1, 60 to 10% by mass of a fibrous reinforcing material and 0.1 to 10% by mass of a polycarbodiimide compound in relation to 100% by mass of the total amount of the thermoplastic resin composition.

9. The thermoplastic resin composition according to claim 8, wherein the fibrous reinforcing material is a glass fiber having an oblate cross section.

10. A thermoplastic resin composition comprising 36.9 to 86.9% by mass of the thermoplastic resin composition according to claims 1, 10 to 60% by mass of a fibrous reinforcing material, 3 to 30% by mass of a flame retardant and 0.1 to 10% by mass of a polycarbodiimide compound in relation to 100% by mass of the total amount of the thermoplastic resin composition.

11. The thermoplastic resin composition according to claim 10, wherein the fibrous reinforcing material is a glass fiber having an oblate cross section.

12. A molded body obtained by molding the thermoplastic resin composition according to claim 1.
